(19) United States
(12) Patent Application Publication
(10) Pub. No.: US 2025/0269696 A1
(43) Pub. Date: Aug. 28, 2025

(54) TIRE PRESSURE INCLUSIVE SEMI-ACTIVE DAMPING

(71) Applicant: Fox Factory, Inc., Duluth, GA (US)

(72) Inventor: Gert-Jan Alexander Vente, Hoschton, GA (US)

(73) Assignee: Fox Factory, Inc., Duluth, GA (US)

(21) Appl. No.: 18/589,237

(22) Filed: Feb. 27, 2024

(51) Int. Cl. B60G 17/019; B60C 23/02; B60G 17/08

(52) U.S. Cl. CPC B60G 17/019; B60C 23/02; B60G 17/08; B60G 2400/52; B60G 2500/10; B60G 2600/184

(57) ABSTRACT

A tire pressure inclusive semi-active damping system is disclosed. The system includes a semi-active shock assembly to provide damping between a tire and a suspended portion of a vehicle. A tire pressure management system (TPMS) obtains a tire pressure value. An electronic suspension control unit (ESCU) receives the tire pressure value from the TPMS and utilizes the tire pressure value to generate an adjustment of at least one damping characteristic of the semi-active shock assembly.

### FIELD OF THE INVENTION

Embodiments of the invention generally relate to a semi-active suspension.

### BACKGROUND

Shock assemblies are used in numerous different vehicles and configurations to absorb some or all of a movement that is received at a first portion of a vehicle before it is transmitted to a second portion of the vehicle. For example, when a front tire of a vehicle hits a rough spot, the encounter will cause an impact force. However, by utilizing suspension components including one or more shock assemblies, the impact force can be significantly reduced or even absorbed completely before it is transmitted to a vehicle operator.

Conventional shock assemblies provide a constant damping rate during compression or extension through the entire length of the stroke. As various types of recreational and sporting vehicles continue to become more technologically advanced, what is needed in the art are improved techniques for varying the performance characteristics of the shock assemblies.

### BRIEF DESCRIPTION OF THE DRAWINGS

Aspects of the present invention are illustrated by way of example, and not by way of limitation, in the accompanying drawings, wherein:

FIG. 1 is a perspective view of a vehicle with tire pressure inclusive semi-active damping, in accordance with an embodiment.

FIG. 2 is a block diagram of an electronic vehicle suspension control system with tire pressure inclusive semi-active damping in communication with an in-vehicle infotainment (IVI) system, in accordance with an embodiment.

FIG. 3 is a block diagram of the system on a shock assembly with tire pressure inclusive semi-active damping integrated into an electronic vehicle suspension control system, in accordance with an embodiment.

FIG. 4 is a perspective side view of the tire pressure inclusive semi-active damping at a single wheel location, in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, and objects have not been described in detail as not to unnecessarily obscure aspects of the present disclosure.

### Terminology

In the following discussion, a number of terms and directional language is utilized. Although the technology described herein is useful on a number of different suspension systems that use a shock assembly, a wheeled vehicle is used in the following description for purposes of clarity.

In general, a suspension system for a vehicle provides a motion modifiable connection between a portion of the vehicle that is in contact with a surface (e.g., an unsprung portion) and some or all of the rest of the vehicle that is not in contact with the surface (e.g., a suspended portion). For example, the unsprung portion of the vehicle that is in contact with the surface can include one or more wheel(s), skis, tracks, hulls, etc., while some or all of the rest of the vehicle that is not in contact with the surface include suspended portions such as a frame, a seat, handlebars, engines, cranks, etc.

The suspension system will include one or numerous components which are used to couple the unsprung portion of the vehicle (e.g., wheels, skids, wings, belt, etc.) with the suspended portion of the vehicle (e.g., seat, cockpit, passenger area, cargo area, etc.). Often, the suspension system will include one or more shock assemblies which are used to reduce feedback from the unsprung portion of the vehicle before that feedback is transferred to the suspended portion of the vehicle, as the vehicle traverses an environment. However, the language used by those of ordinary skill in the art to identify a shock assembly used by the suspension system can differ while referring to the same (or similar) types of components. For example, some of those of ordinary skill in the art will refer to the shock assembly as a shock absorber, while others of ordinary skill in the art will refer to the shock assembly as a damper (or damper assembly).

The term “active”, as used when referring to a valve or shock assembly component, means adjustable, manipulatable, etc., during typical operation of the valve. For example, an active valve can have its operation changed to thereby alter a corresponding shock assembly characteristic damping from a “soft” setting to a “firm” setting (or a stiffness setting somewhere therebetween) by, for example, adjusting a switch in a passenger compartment of a vehicle. Additionally, it will be understood that in some embodiments, an active valve may also be configured to automatically adjust its operation, and corresponding shock assembly damping characteristics, based upon, for example, operational information pertaining to the vehicle and/or the suspension with which the valve is used.

Similarly, it will be understood that in some embodiments, an active valve may be configured to automatically adjust its operation, and corresponding shock assembly damping characteristics, based upon received user input settings (e.g., a user-selected “comfort” setting, a user-selected “sport” setting, and the like). In many instances, an “active” valve is adjusted or manipulated electronically (e.g., using a powered solenoid, electric motor, poppet, or the like) to alter the operation or characteristics of a valve and/or other component. As a result, in the field of suspension components and valves, the terms “active”, “electronic”, “electronically controlled”, and the like, are often used interchangeably.

The term “manual” as used when referring to a valve or shock assembly component means manually adjustable, physically manipulatable, etc., without requiring disassembly of the valve, damping component, or shock assembly which includes the valve or damping component. In some instances, the manual adjustment or physical manipulation of the valve, damping component, or shock assembly which includes the valve or damping component, occurs when the valve is in use. For example, a manual valve may be adjusted to change its operation to alter a corresponding shock assembly damping characteristic from a “soft” setting to a “firm” setting (or a stiffness setting somewhere therebetween) by, for example, manually rotating a knob, pushing or pulling a lever, physically manipulating an air pressure control feature, manually operating a cable assembly, physically engaging a hydraulic unit, and the like. For purposes of the present discussion, such instances of manual adjustment/physical manipulation of the valve or component can occur before, during, and/or after “typical operation of the vehicle”.

It should further be understood that a vehicle suspension may also be referred to using one or more of the terms “passive”, “active”, “semi-active” or “adaptive”. As is typically used in the suspension art, the term “active suspension” refers to a vehicle suspension which controls the vertical movement of the wheels relative to vehicle. Moreover, “active suspensions” are conventionally defined as either a “pure active suspension” or a “semi-active suspension” (a “semi-active suspension” is also sometimes referred to as an “adaptive suspension”). In a conventional “pure active suspension”, a motive source such as, for example, an actuator, is used to move (e.g. raise or lower) a wheel with respect to the vehicle. In a “semi-active suspension”, no motive force/actuator is employed to adjust move (e.g. raise or lower) a wheel with respect to the vehicle.

Rather, in a “semi-active suspension”, the characteristics of the suspension (e.g. the firmness of the suspension) are altered during typical use to accommodate conditions of the terrain and/or the vehicle. Additionally, the term “passive suspension”, refers to a vehicle suspension in which the characteristics of the suspension are not changeable during typical use, and no motive force/actuator is employed to adjust move (e.g. raise or lower) a wheel with respect to the vehicle. As such, it will be understood that an “active valve”, as defined above, is well suited for use in a “pure active suspension” or a “semi-active suspension”.

In the following discussion, an electronically adjustable component of the system on a shock assembly may be active and/or semi-active. In general, the electronically adjustable component will have one or more electronically adjustable features controlled by a motive component such as a solenoid, stepper motor, electric motor, or the like. In operation, the electronically adjustable component will receive an input command which will cause the motive component to move, modify, or otherwise change one or more aspects of one or more electronically adjustable features.

Embodiments of different active valve suspension and components that may be utilized are disclosed in U.S. Pat. Nos. 8,838,335; 9,353,818; 9,682,604; 9,797,467; 10,036,443; 10,415,662; the content of which are incorporated by reference herein, in their entirety.

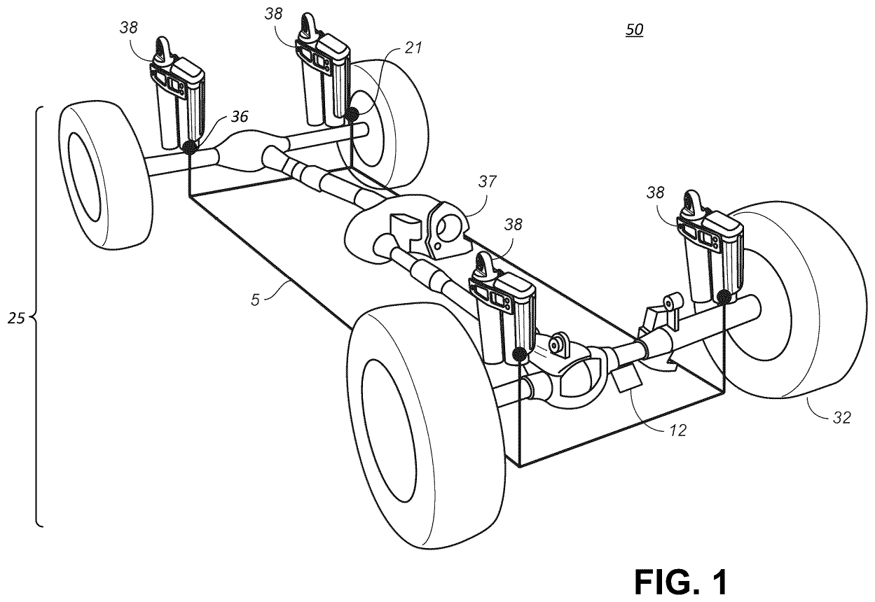

Referring now to FIG. 1, a perspective view of a vehicle 50 with a tire pressure inclusive semi-active damping system 25 is shown in accordance with an embodiment. Although a wheeled vehicle 50 is used in the discussion, the technology is also suited for use in other vehicles such as, but not limited to a bicycle, an electric bike (e-bike), a hybrid bike, a scooter, a motorcycle, an ATV, a vehicle with three or more wheels (e.g., a UTV such as a side-by-side, a car, truck, etc.), an aircraft, and the like. However, in the following discussion, and for purposes of clarity, a 4-wheeled vehicle 50 is utilized as the example vehicle upon which the tire pressure inclusive semi-active damping is shown and described.

In one embodiment, vehicle 50 is a generic vehicle such as a car, truck, side-by-side, or the like, driven by an engine and consisting of an unsprung portion (such as tires 32, drive train 37, axles, etc.), a sprung portion (such as a cockpit, seating area, etc.), and a tire pressure inclusive semi-active damping system that utilizes at least one semi-active shock assembly 38 to couple the sprung portion of the vehicle with the unsprung portion.

In one embodiment, tire pressure inclusive semi-active damping system 25 includes one or more electronically actuated components, interactive components, and/or control features such as for example, active and/or semi-active shock assemblies 38, vehicle dynamic module (VDM) 21, one or more devices 12 (such as sensor or the like), a power source, smart components, and the like. In one embodiment, some or all of the components will communicate via a communications network 5 (described in further detail herein).

In one embodiment, the one or more sensors include tire pressure monitoring system (TPMS) 75 and the associated tire pressor sensor 73 are described in further detail herein.

In general, the one or more sensor(s) could be used to monitor and/or measure things such as temperature, voltage, current, resistance, noise (such as when a motor is actuated, fluid flow through a flow path, engine knocks, pings, etc.), positions of one or more components of vehicle 50 (e.g., shock positions, ride height, pitch, yaw, roll, etc.), and the like. In one embodiment, the one or more sensor(s) could be forward looking terrain, vibrations, bump, impact event, angular measurements, and the like.

Additional information for vehicle suspension systems, sensors, and their components as well as adjustment, modification, and/or replacement aspects including manually, semi-actively, semi-actively, and/or actively controlled aspects and wired or wireless control thereof is provided in U.S. Pat. Nos. 8,838,335; 9,353,818; 9,682,604; 9,797,467; 10,036,443; 10,415,662; the content of which are incorporated by reference herein, in their entirety.

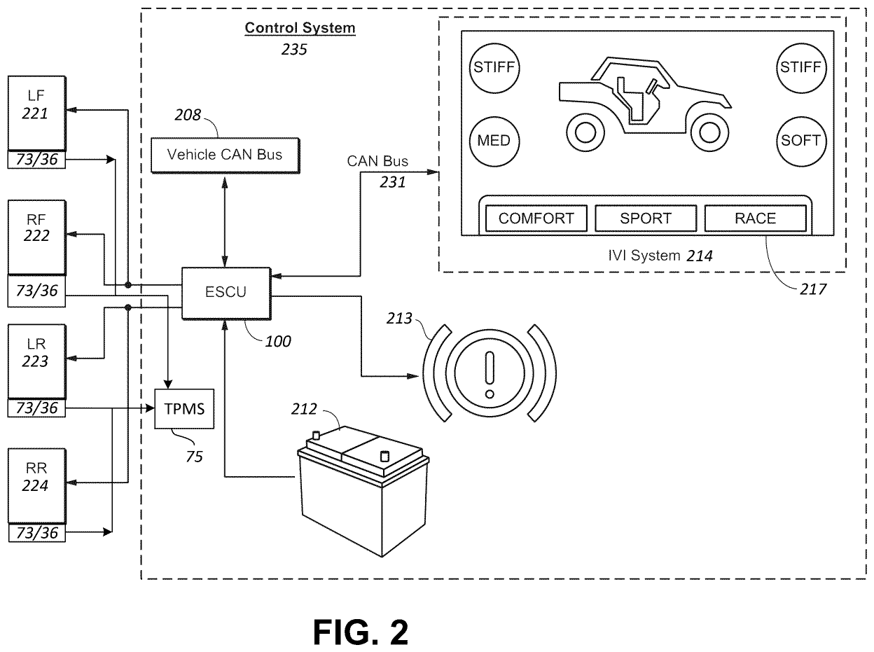

Referring now to FIG. 2, a block diagram of a tire pressure inclusive semi-active damping system 25 is shown in accordance with an embodiment. In one embodiment, tire pressure inclusive semi-active damping system 25 includes a plurality of semi-active shock assemblies 38, an electronic vehicle suspension control system 235 and suspension control application 217 on IVI system 214. Basically, the tire pressure inclusive semi-active damping system 25 shown in FIG. 2 is based on the vehicle 50 from FIG. 1 for purposes of clarity. However, it should be appreciated that in another embodiment, the vehicle suspension control system will be for a different vehicle and/or have different components.

In one embodiment, there is at least one semi-active shock assembly 38 located at each of a vehicle suspension location (e.g., at each tire 32). For example, in a four wheeled vehicle there would be a semi-active shock assemblies 38 at the left front 221, the right front 222, the left rear 223, and the right rear 224. In one embodiment, there is a tire pressure sensor 73 located with the tire 32 at each of the vehicle suspension locations. In one embodiment, there is a tire pressure sensor 73 located with one or some of the tires 32.

In one embodiment, there is at least one receiver 36 located at each of the vehicle suspension locations to wirelessly receive the tire pressure data from the tire pressure sensor 73. In one embodiment, the tire pressure data is provided to the TPMS 75. In one embodiment, the TPMS 75 provides the information to the electronic suspension control unit (ESCU) 100. In one embodiment, the tire pressure information is provided directly to the ESCU 100 from the tire pressure sensor 73 and/or the receiver 36.

In one embodiment, semi-active shock assemblies 38, are selected from the shock assembly types such as, an in-line shock assembly, a piggyback shock assembly, a compression adjust only shock assembly, a rebound adjust only shock assembly, an independent compression and rebound adjust shock assembly, a dependent compression and rebound adjust single valve shock assembly, and the like. Additional information for vehicle active suspension systems can be found in U.S. Pat. No. 10,933,710 which is incorporated by reference herein, in its entirety.

Although electronic vehicle suspension control system 235 is shown as interacting with four semi-active shock assemblies 38 (and four tire pressure sensors 73 and/or receivers 36) such as would be likely found in a four wheeled vehicle suspension configuration, it should be appreciated that the technology is well suited for application in other vehicles with different suspension configurations. The different configurations can include two-wheel suspension configuration like that of a bicycle, e-bike, motorcycle, etc.; a one, two or three “wheel” suspension configuration like that of a snowmobile, trike, side-by-side, aircraft, etc., a plurality of shock assemblies at each of the suspension locations such as found in off-road vehicles, UTV, powersports, heavy trucking, RV, agriculture, and the like.

In one embodiment, electronic vehicle suspension control system 235 includes ESCU 100, vehicle CAN bus 208, CAN Bus 231 to IVI system 214, warning indicator 213, and power source 212. It should be appreciated that in an embodiment, one or more components shown within electronic vehicle suspension control system 235 would be located outside of electronic vehicle suspension control system 235, and similarly additional components would be located within electronic vehicle suspension control system 235. In general, vehicle CAN bus 208 could be any vehicle communication bus and CAN bus 231 could be Ethernet, LIN, or other digital communication bus.

In one embodiment, the suspension control application 217 on IVI system 214 utilizes a communication protocol that basically anonymizes the vehicle CAN data. For example, in one embodiment of a standard OS for IVI system 214, the anonymized communication protocol is android automotive (which is different than Android Auto).

In one embodiment, the anonymized communication protocol utilizes a structure such as Vehicle Hardware Abstraction Layer (VHAL) to define certain properties OEMs can implement. In general, VHAL is a layer between the suspension control application 217 (running on IVI system 214) and the individual ECUs of the vehicle that communicate over CAN. In other words certain vehicle properties are accessible in the VHAL anonymized communication protocol without needing to know the exact CAN message. In one embodiment, the VHAL anonymized communication protocol allows suspension control application 217 to include an API that defines certain vehicle properties it would like to subscribe to such as, for example, PERF_STEERING_ANGLE (e.g., a property name).

Thus, in one embodiment, suspension control application 217 does not need to see the raw CAN data. As a result, the OEM can send suspension control application 217 the anonymized property instead of the RAW CAN message. In so doing, one embodiment creates a universal way of interfacing that is OE agnostic and does not require suspension control application 217 to know the individual CAN IDs/messages, which will keep the vehicle secure and stable. In one embodiment, in addition to (or in place of) the “standard” set of Android anonymized properties, suspension control application 217 can include and use its own set of custom anonymized properties as part of its API (e.g., roll, pitch, yaw . . . etc.). In one embodiment, the custom anonymized properties developed for suspension control application 217 can be provided to the OEs for implementation in order to facilitate additional/enhanced/modified interface capabilities between the individual ECUs of the vehicle and suspension control application 217.

In one embodiment, inputs to the suspension control application 217 on IVI system 214 may not necessarily be received as an input from a sensor. For example, another type of input received by the suspension control application on the IVI system 214 may be a combined input generated based on a calculation from multiple sensory inputs. For example, an OE uses occupant sensors to determine a combined input to the IVI system 214; e.g., 3 sensors active might indicate one driver and two rear passengers, three front occupants on a bench seat, or the like. In one embodiment, the OE could choose to code all of the different combinations of occupant configurations to unique identifiers that are then delivered under the custom anonymized properties, Android automotive protocol, or the like.

In one embodiment, ESCU 100 includes a processor. In operation, both compression and rebound oil flows through independent sophisticated multistage blended circuits in ESCU 100 to maximize suspension control. In one embodiment, ESCU 100 will control each of the plurality of semi-active shock assemblies 38 located at each vehicle wheel suspension location, determine a type of shock assembly at each vehicle wheel suspension location, automatically tune a vehicle suspension based on the determined type of shock assemblies at each vehicle wheel suspension location, automatically monitor the plurality of shock assemblies and determine when a change has been made to one or more of the plurality of shock assemblies, and automatically re-tune the vehicle suspension based on the change to one or more of the plurality of shock assemblies.

In one embodiment, if there is no suspension control application 217 on IVI system 214 communicating with the electronic vehicle suspension control system 235, the suspension configuration will be identified on the display of IVI system 214 by a warning indicator 213.

In general, IVI system 214 will include a GUI and suspension control application 217 on IVI system 214 will present a suspension configuration and operational information about the suspension configuration, e.g., vehicle suspension settings and the like, in a user interactive format, on the IVI system 214 GUI located in the vehicle.

In one embodiment, suspension control application 217 on IVI system 214 will present vehicle suspension setting information in a user interactive format on a display, where the IVI system 214 will have a touch input capability to receive an input from a user. In one embodiment, as described herein, suspension control application 217 on IVI system 214 is also programmable to present suspension configuration information, rebound configuration information and/or suspension setting information in a user interactive format on a display.

In one embodiment, the vehicle suspension setting information can include a plurality of different vehicle suspension mode configurations, settings and the like. In one embodiment, suspension control application 217 on IVI system 214 will also provide identification of which configuration or mode is currently active on the vehicle suspension. In one embodiment, the plurality of different vehicle suspension mode configurations is user selectable.

If one or more of semi-active shock assemblies 38 are automatically adjustable, in one embodiment, suspension control application 217 on IVI system 214 will automatically adjust one or more of the pluralities of shock assemblies of the tuned vehicle suspension based on external conditions such as, weather, terrain, ground type (e.g., asphalt, concrete, dirt, gravel, sand, water, rock, snow, etc.), and the like.

In one embodiment, suspension control application 217 on IVI system 214 will automatically adjust one or more of the pluralities of semi-active shock assemblies 38 of the tuned vehicle suspension based on one or more sensor inputs received from sensors such as an inertial gyroscope, an accelerometer, a magnetometer, a steering wheel turning sensor, a single or multi spectrum camera, a lidar and/or radar, the TPMS system 75 (and/or tire pressure sensors 73), and the like.

In one embodiment, the electronic vehicle suspension control system 235 characteristics displayed by suspension control application 217 on IVI system 214 can be set at the factory, manually adjustable by a user, or automatically adjustable by a computing device using environmental inputs and the like. In one embodiment, the adjustable characteristics for the semi-active shock assemblies 38 are adjusted based on a user input. For example, via user interaction with IVI system 214 and the menus, configurations, and options. Additional information for IVI systems and the integration with vehicle structure, suspension components, suspension component controller(s) and data processing system as described in U.S. Pat. Nos. 7,484,603; 8,838,335; 8,955,653; 9,303,712; 10,060,499; 10,443,671; 10,737,546; 10,933,710; and 11,796,030, the content of each of which are incorporated by reference herein, in their entirety.

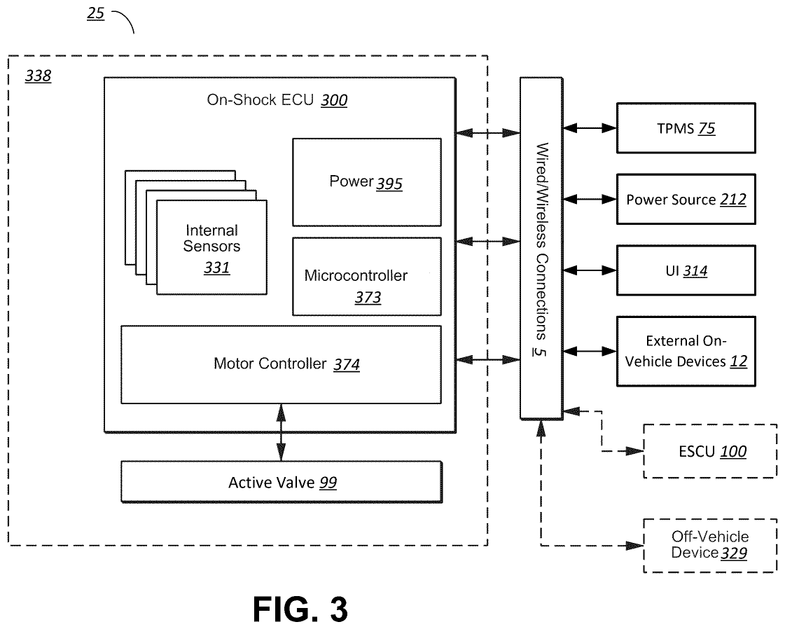

Referring now to FIG. 3, a block diagram of a system on a shock assembly with tire pressure inclusive semi-active damping system 25 integrated into an electronic vehicle suspension control system, ESCU 100, is shown in accordance with an embodiment. In general, the system on a shock assembly with tire pressure inclusive semi-active damping system 25 is similar to the functionality described in the discussion of FIG. 2. However, in FIG. 3, one or more components of the tire pressure inclusive semi-active damping system 25 are located on a system on a semi-active shock assembly 338. However, other than the differences apparent or described herein, the general operation of the components is similar although they may be being performed by different components and/or in different locations.

In one embodiment, tire pressure inclusive semi-active damping system 25 includes one or more electronically actuated components, interactive components, and/or control features. For example, in one embodiment, tire pressure inclusive semi-active damping system 25 includes at least one system on a semi-active shock assembly 338, and a communications network 5. In one embodiment, tire pressure inclusive semi-active damping system 25 also optionally utilizes a power source 212, and optionally communicates with none, one, some or all of a user interface 314, external on-vehicle devices 12 (such as tire pressure sensors 73, receiver 36, or the like), the vehicle ESCU 100, and one or more off-vehicle devices 329.

In one embodiment, an off-vehicle device 329 could be, for example, a trailer being towed. In one embodiment, system on a shock assemblies (and/or other interactive components) of the trailer can be added to the communications network 5. Further, if there was a vehicle, e.g., a side-by-side loaded on the trailer, the communications network 5 could expand to the tow vehicle, the trailer, and the side-by-side such that the system on a shock assemblies (and/or other interactive components) on each of the vehicles would be able to work in conjunction. For example, the tow vehicle hits bump, the information is passed to the trailer suspension which would be prepped for the event impact, and the information is also passed to the side-by-side, such that the side-by-side's suspension is adjusted to provide better interaction between the side-by-side and the trailer as the impact event is encountered by the trailer.

In another embodiment, an off-vehicle device 329 could be, for example, components of a second ESCU 100 located on a second vehicle.

In one embodiment, tire pressure inclusive semi-active damping system 25 can include suspension components such as sway bars, and the like. For example, in one embodiment, one or a plurality of other component(s) of vehicle 50 are also smart component(s). In one embodiment, the smart component(s) will include connective features that allow them to communicate wired or wirelessly with one or more of the electronically actuated components, interactive components, control features, and/or the like of tire pressure inclusive semi-active damping system 25.

In one embodiment, data (including real-time data) is collected or provided from the smart component(s), electronically actuated components, interactive components, control features, and/or the like to one or more components of the tire pressure inclusive semi-active damping system 25. Depending upon the connected component, the data may be location data, sensor data, telemetry data, and the like. In general, telemetry data can include data such as angle, orientation, velocity, acceleration, RPM, operating temperature, and the like.

In one embodiment, tire pressure inclusive semi-active damping system 25 can include all of the components shown in the schematic diagram of FIG. 3. In one embodiment, tire pressure inclusive semi-active damping system 25 would include some of the components shown in the schematic diagram of FIG. 3. In one embodiment, tire pressure inclusive semi-active damping system 25 will only include a limited number of the components shown in the schematic diagram of FIG. 3.

In one embodiment, communication network 5 uses existing vehicle wiring harness and/or communications systems. In one embodiment, communication network 5 is a stand-alone communications network. That is, instead of utilizing existing vehicle wiring harness or communications systems, the communication network 5 will be specifically designed for use with the tire pressure inclusive semi-active damping system 25. Thus, in one embodiment, the installation of tire pressure inclusive semi-active damping system 25 will not require any taping into existing vehicle wiring. In one embodiment, communication network 5 may provide communication with one or some components of the vehicle such as via user interface 314, external on vehicle devices 12, the vehicle ESCU 100, off-vehicle device 329, or the like. In one embodiment, user interface 314 is selected from an interface such as, but not limited to, a touchpoint interface, a mobile device, an IVI system 214, a button/switch type interface or the like.

In other words, in one embodiment, the components of tire pressure inclusive semi-active damping system 25 are not required to be added to or connected with, the main vehicle wiring harness. In one embodiment, the components of tire pressure inclusive semi-active damping system 25 do not require connectivity with the vehicle can bus (or ESCU 100) to connect, access, control, monitor, adjust, modify, receive feedback, communicate or otherwise operate within the parameters of the vehicle 50 upon which they are installed. Instead, in one embodiment, the components of tire pressure inclusive semi-active damping system 25 are added to the vehicle and use their own communications network 5 to act as separately controlled items to monitor/adjust/modify or otherwise control the performance characteristics thereof.

In one embodiment, the tire pressure inclusive semi-active damping system 25 provides a plug and play capability such that one or more component are removed, replaced, added, or the like, to the tire pressure inclusive semi-active damping system 25 by adding the component to (or removing the component from) the vehicle 50 and then providing the component with access to (or removing the component's access from) the communication network 5.

In one embodiment, the systems on a semi-active shock assembly 338 may communicate with a vehicle ESCU 100 via the vehicle can bus (or user interface 314, or the like) to provide sensor and/or performance information that can be used by the vehicle ESCU 100 for vehicle performance information such as antilock braking, sway information, drift information, wheel spin information, ride height information, and/or data from other on-vehicle device(s) 12 that may be utilized by the vehicle ESCU 100.

In one embodiment, communication network 5 is a wired communication network 5 (such as via a wiring harness or the like). In one embodiment, communication network 5 is a wireless communication network. In one embodiment, communication network 5 is a hybrid communication network utilizing both wired and wireless communication capabilities.

In one embodiment, communication network 5 utilizes a communication protocol designed for low latency and long battery life. In one embodiment, the network implements the proprietary low-latency low-power radio protocol to provide an effective transport for communication between one or more components of tire pressure inclusive semi-active damping system 25. Further information, detail, and description of low latency, power sources, and power consumption reduction based performance is provided in U.S. patent application Ser. No. 17/562,020, the content of which is incorporated by reference herein, in its entirety.

In one embodiment, power for one or more of the components of tire pressure inclusive semi-active damping system 25 is received over a wired connection. For example, the motive component such as a solenoid, stepper motor, electric motor, or the like that operates the active valve 99 in one or more system on a semi-active shock assembly 338 would receive its power from a power source 212 coupled with the wiring harness (e.g., the vehicle battery, alternator, a power supply incorporated with user interface 314, a power supply coupled with another of the one or more system on a semi-active shock assembly 338, a reserve or extra power supply for auxiliary components, or the like).

In one embodiment, one or more system on a semi-active shock assembly 338 will include its own power source 395 and the actuator(s) (e.g., motive component such as a solenoid, stepper motor, electric motor, or the like) that operates the active valve 99 would receive its operating power therefrom. In other words, one or more of the system on a semi-active shock assembly 338 would be a self-contained unit which would be able to perform an adjustment to at least one performance characteristic of the shock assembly. In one embodiment, the adjustment may be generated by the on-shock ECU 300, similar to how it is generated by ESCU 100. In one embodiment, the adjustment may be received vie the communications network 5 from another component such as user interface 314, an off-vehicle device 329, ESCU 100, or the like. Additional details regarding ECU and ESCU operation is found in U.S. Pat. Nos. 11,697,317 and 11,796,030, the content of which are incorporated by reference herein, in their entirety.

Referring still to FIG. 3, in one embodiment, system on a semi-active shock assembly 338 includes a number of components such as internal sensors 331, a power source 395, a microcontroller 373, and motor controller 374. In one embodiment, system on a semi-active shock assembly 338 includes a plurality of electronics coupled therewith to collect data, actuate mechanisms, and communicate with external devices through wired and wireless protocols. In general, the electronic devices can include Master ECU, other shock-electronic-assemblies, HMIs, IMUs, and other sensors.

In one embodiment, internal sensors 331 may be one or more sensor(s) to monitor and/or measure things such as tire pressure, temperature, voltage, current, resistance, noise (such as when a motor is actuated, fluid flow through a flow path, engine knocks, pings, etc.), positions of one or more components of vehicle 50 such as, system on a semi-active shock assembly 338 settings (such as preload, compression settings, rebound settings, lockout, or the like) ride height, pitch, yaw, roll, and the like. In one embodiment, the one or more sensor(s) could be forward looking terrain sensors, vibration sensors, bump sensors, impact event sensors, angular measurements sensors, and the like. Additional information about sensors, other sensor types, and their operations are provided in U.S. Pat. Nos. 8,838,335; 9,353,818; 9,682,604; 9,797,467; 10,036,443; 10,415,662; the content of which are incorporated by reference herein, in their entirety.

Although shown in certain locations in FIG. 3, in one embodiment, one, some, or all of the components shown in FIG. 3 could be located in other locations. For example, one, some, or all of the components could be located on the sides of components, at the handlebars, at a foot peg (or footwell), carried by the rider if it is wireless, located on a mount attached to a portion of the vehicle 50, etc. Thus, the use of the locations of components as shown in FIG. 3 are indicative of one embodiment, which is provided for purposes of clarity.

In one embodiment, the components of tire pressure inclusive semi-active damping system 25 are integrated with the vehicle structure, suspension components, suspension component controller(s) and data processing system as described in U.S. Pat. Nos. 7,484,603; 8,838,335; 8,955,653; 9,303,712; 10,060,499; 10,443,671; 10,737,546; and 10,933,710 the content of each of which are incorporated by reference herein, in their entirety.

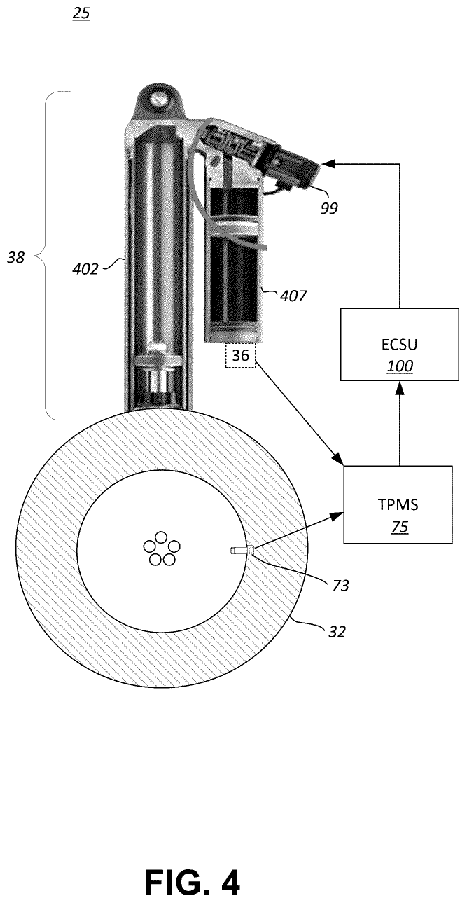

With reference now to FIG. 4, a perspective side view of the tire pressure inclusive semi-active damping system 25 for a single tire 32 is shown in accordance with an embodiment.

Semi-active shock assembly 38 may include eyelets, a housing 402, a spring, piston shaft, and/or piggyback (or external reservoir 407). In general, the housing 402 includes a piston and chamber and the external reservoir 407 includes a floating piston and pressurized gas to compensate for a reduction in volume in the main damper chamber of the semi-active shock assembly 38 as the piston shaft moves into the housing. Fluid communication between the main chamber of the shock assembly and the external reservoir 407 may be via a flow channel including an adjustable needle valve. In its basic form, the semi-active shock assembly 38 works in conjunction with the spring and controls the speed of movement of the piston shaft by metering incompressible fluid from one side of the piston to the other, and additionally from the main chamber to the reservoir 407, during a compression stroke (and in reverse during the rebound or extension stroke)

In one embodiment, the shock assembly 38 is a coil spring shock assembly. In one embodiment, the semi-active shock assembly 38 is a different type of shock assembly such as, but not limited to, an air sprung fluid shock assembly, a stand-alone fluid shock assembly, and the like.

The semi-active shock assembly 38 includes an active valve 99 (e.g., an electronic valve that includes an actuator or other motive component such as a solenoid, stepper motor, electric motor, or the like) that controls the fluid flow through at least one pathway. In so doing, the active valve 99 allows damping characteristic changes to be made to the semi-active shock assembly 38. In one embodiment, the damping characteristic changes are made by an ESCU 100 and are based on sensor input, environment/terrain, speed, performance, weather, and the like. Tire 32 includes a tire pressure sensor 73 that performs real-time (or near-real time) tire pressure sensing and provides the tire pressure information to the TPMS 75. Although a single tire is shown, it should be appreciated that one, some, or all of the tires on a vehicle will include a tire pressure sensor 73 and one, some, or all of the tire pressure sensors 73 will provide the tire pressure information to the TPMS 75.

For example, in one embodiment, each tire 32 will have a tire pressure sensor 73 with a different identifier and a wireless transmission capability. When a tire pressure sensor 73 is added to a tire, the tire pressure sensor 73 will periodically transmit its identifier and the pressure information. As each tire pressure sensor 73 is added to a vehicle, it will also be identified and added to the TPMS 75. For example, tire pressure sensor 73 with identifier 11ae is installed in the left front tire of the vehicle. As such, tire pressure sensor 73 with identifier 11ae will be added to the TPMS 75 as the tire pressure information for the left front tire. This process will similarly occur for any additional tires on the vehicle and their location will also be assigned to the TPMS 75. As such, the TPMS 75 will be able to monitor the individual tire pressures for each tire on the vehicle.

In one embodiment, the communications network 5 (of FIG. 1), and thus the TPMS 75, will include a receiver 36 located near each of the tires 32 of the vehicle 50. The receiver 36 would use short range communications protocols to ensure that it is only receiving a tire pressure broadcast from the tire it is located proximal. In so doing, the information would be passed from the tire pressure sensor 73 to the proximal receiver 36 and then on to the TPMS 75. In one embodiment, by providing a close proximity receiver 36, the broadcast range (and thus power requirements) of the tire pressure sensor 73 can be significantly reduced (e.g., to a few inches, centimeters, etc.) and the tire pressure sensor 73 broadcast will not be required to include an identifier. Instead, the identifier will be the receiver identifier that is used by the TPMS 75 to identify which tire 32 is associated with which pressure.

In general operation of a suspension system, a tire 32 will act similar to a spring. If it is fully inflated it is firm, if it is less than fully inflated it is softer. Viewing the tire 32 as a spring, is useful to note the tire behavior and “spring rate” of the tire 32 varies based on the internal pressure. As such, different pressures can lead to unexpected changes in traction, grip, comfort, handling and safety. In other words, there is a loss in optimum ride control & damping due to tire pressure fluctuations. Thus, by incorporating the TPMS 75 information into the active shock assembly damping calculations, the tire 32 is calculated as a second spring (or additional spring rate) and, as such, the actual tire pressure values are used to establish and modify the damping characteristics for optimum ride control & damping. Thus, by adding the TPMS 75 to the active shock system, the existing black hole of tire pressure ignorance in damping tunes is not only addressed, but is actively accounted by the system.

Thus, the TPMS 75 information is added to and utilized by the electronic suspension control unit (ESCU) 100 to calculate and adjust one or more damping characteristics of one, some, or all semi-active shock assemblies 38 of the suspension. For example, the TPMS 75 information is used as additional input to the active valve calculations performed by the ESCU 100, and the damping control for each semi-active shock assembly 38 is optimized for over/under inflation conditions. This can be done specifically for each corner to bring better balance and control to the vehicle 50. The TPMS 75 information can also be used for specific drive modes such as low-pressure off roading, etc. That is, the TPMS 75 information could be used per tire 32 (e.g., per semi-active shock assembly 38) to adjust the tire specific suspension based on the tire pressure. For example, assuming a right front 222 tire 32 is at 40 psi (max recommended) and a left front 221 tire 32 is at 30 psi. The difference in the tire pressures will cause different suspension feel and/or performance. For example, the right front 222 tire 32 would be stiffer or firmer than the left front 221 tire 32. This difference could result in asymmetric suspension performance.

However, by incorporating the TPMS 75 information into the active and/or semi-active suspension calculations performed by the ESCU 100, the suspension can be adjusted, or tuned, to mitigate the tire pressure caused asymmetric suspension performance. For example, since the left front 221 tire 32 is lower than max recommended, the semi-active shock assembly 38 of the left front 221 tire 32 would be set to a firmer setting (than that of the right front 222 semi-active shock assembly 38) to provide similar performance/feel for both front tires. Similarly, as the left front 221 tire 32 is lower than max recommended, the shock assembly of the right front 222 tire 32 would be set to a softer setting (than that of the left front 221 semi-active shock assembly 38) to provide similar performance/feel for both front tires.

In one embodiment, the TPMS 75 information would also be speed and/or performance dependent. For example, in a vehicle 50 operating well within its performance envelope, the adjusted suspension performance established by the ESCU 100 would provide better handling and feel without compromising the performance of the vehicle 50.

However, if the vehicle is being pushed, or working at a closer end to the performance envelope, the TPMS 75 information and associated suspension performance characteristic changes determined by the ESCU 100 might reach a threshold level of performance at which point the ESCU 100 would provide a warning (such as via warning indicator 213, IVI 214, mobile alert, indicator in the suspension control application 17, or the like) to the operator that the tire pressures are significantly different and an air pressure adjustment should be performed. For example, a warning displayed on an IVI system 214, a message to a mobile phone, an indicator in the suspension control application 17, a visual indicator, an audio alarm, or the like, could be used to provide an alert (or other warning indicator 213) regarding the difference in tire pressures and the threshold of performance that is being approached. At that time, the operator could adjust the tire pressures, confirm awareness of the disparate tire pressure issue, or the like. In so doing, the TPMS 75 information would be used by the ESCU 100 in a myriad of ways far beyond the present utilization of a low tire pressure warning. Instead it can be utilized to provide feedback to the ESCU 100, to address possible and/or likely vehicle performance and/or capabilities that are being deleteriously affected by the tire pressure, by any differences in pressure between two or more tires, and the like.

In one embodiment, the ESCU 100 could include different thresholds depending upon the tire location. For example, a lower pressure front tire 32 might have a larger performance or controllability impact than a lower pressure rear tire and/or pressure differential between front tires and/or rear tires. Thus, in one embodiment, the front tire pressure threshold could be, for example, 20% below manufacturer max psi, and 20% differential between the front tires, etc.; while the rear tire pressure threshold could be 40% below manufacturer max psi, 30% differential between the rear tires, etc.

Although a few percentages are provided in one embodiment, it should be appreciated that in another embodiment the threshold values could be higher or lower. Moreover, it should be appreciated that in different performance scenarios, the threshold values could be higher or lower.

In one embodiment, the TPMS 75 information could also be received by the ESCU 100 and then provided as an alert to the vehicle operator via the IVI system 214, or the like. For example, if the vehicle 50 is operating on a road (or hard surface) and then moves to sand or other soft terrain, the ESCU 100 will adjust the suspension for the softer terrain, and the IVI system 214 (or the like) will be used to inform the vehicle operator of the overinflated tires (for the softer terrain) and an action to take (e.g., deflate the tires to a lower pressure).

In one embodiment, the vehicle 50 could include a tire inflation/deflation system to allow the tire pressure to be controlled (automatically and/or manually) as part of the suspension setting process. For example, in an automated embodiment, the tire inflation/deflation system will adjust the tire pressure automatically based on input from the ESCU 100 (or the like).

In a manual embodiment, the on-board tire inflation/deflation system will wait for a user input (such as a command, input via IVI system 214, etc.), before adjusting the tire pressure based on the adjustment provided by the ESCU 100 (or the like).

Thus, by incorporating the TPMS 75 information into the semi-active damping system, the ESCU 100 can include psi specific damping for each tire 32 of a vehicle. Further, by including the tire 32 manufacture information in the ESCU 100 database, the spring rate equivalent can be determined for a given tire 32 with a given psi. Thus, the change in psi for a tire 32 will, in one embodiment, be addressed similar to a spring rate change by the ESCU 100 to determine any damping changes that should be made.

In so doing, the disclosed tire pressure inclusive semi-active damping system 25 will be able to detect out of balance conditions from low tire pressures, identify high frequency vibrations caused by improper tire pressure that may be detected by other vehicle sensors, and adjust damping characteristics of one or more of the semi-active shock assemblies 38 to account for the tire pressure issues that would otherwise affect ride quality.

In one embodiment, the tire pressure inclusive semi-active damping system 25 will also be able to utilize the TPMS 75 information in conjunction with other vehicle sensors, to track and filter consistent frequencies, vibrations, and/or amplitude within the TPMS 75 information to evaluate any out of balance conditions and/or identified vibrations for indications of wheel/tire 32 damage.

For example, if the tire pressure is within the appropriate range, and sensor information is identifying tire 32 as having out of balance issues, vibrations, or the like, the ESCU 100 will be able to determine there is a likely problem with the wheel/tire 32 or a component coupled therewith and provide a warning/alert to the operator of the vehicle. The ESCU 100 may identify the problem or provide a suggestion for the vehicle operator to stop, slow, or the like and inspect the vehicle around the wheel/tire 32. In general, the problem could be damage to the tire, damage to the rim, an out of balance tire/wheel, axle damage, sway bar connection/disconnection/problems, tie rod problems/damage, shoch assembly problems/damage, other suspension component problems/damage, etc.

By utilizing the ESCU 100 to alert the vehicle operator, the vehicle can be safely slowed, stopped, and inspected to prevent further damage, an accident, loss of control, or the like.

In addition, the tire pressure inclusive semi-active damping system 25 will provide safety and feedback for a vehicle operator when the vehicle is operating in, and/or transitioning between off-road and on-road terrain. The tire pressure inclusive semi-active damping system 25 will also change damping stiffness to reduce roll when low tire pressure is identified.

Moreover, the tire pressure inclusive semi-active damping system 25 will not only work with semi-active shock assemblies 38, but can also be used in conjunction with eSway, Live (X2), and the like to improve traction, acceleration, braking, and the like.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A system comprising:
a semi-active shock assembly configured to provide an amount of damping between a tire and a suspended portion of a vehicle;
a tire pressure management system (TPMS) to obtain a tire pressure value for said tire; and
an electronic suspension control unit (ESCU), said ESCU configured to:
receive said tire pressure value from said TPMS; and
utilize said tire pressure value to generate an adjustment of at least one damping characteristic of said semi-active shock assembly.

2. The system of claim 1, wherein said semi-active shock assembly comprises:
an active valve configured to:
receive said adjustment from said ESCU; and
modify a damping characteristic of said semi-active shock assembly.

3. The system of claim 2, wherein said adjustment is automatically provided from said ESCU to said active valve.

4. The system of claim 1, wherein said TPMS further comprises:
at least one receiver to wirelessly receive said tire pressure value from a tire pressure sensor, wherein said at least one receiver is coupled with said semi-active shock assembly.

5. The system of claim 1, wherein said TPMS further comprises:
at least one receiver to wirelessly receive said tire pressure value from a tire pressure sensor, wherein said at least one receiver is coupled with said suspended portion of said vehicle.

6. The system of claim 1, wherein said ESCU generates said adjustment of said at least one damping characteristic of said semi-active shock assembly based on additional data from a group consisting of: location data, performance data, terrain data, and telemetry data.

7. The system of claim 1, further comprising:
a user interface communicatively coupled with said ESCU, said user interface selected from a group consisting of: an in-vehicle infotainment (IVI) interface, a mobile device, an audible alarm, a visual alarm, and a switch, wherein said ESCU is configured to provide a warning, via said user interface, when said tire pressure value is outside of a terrain based threshold.

8. The system of claim 7, further comprising:
a plurality of semi-active shock assemblies configured to provide an amount of damping between a plurality of tires and said suspended portion of said vehicle;
said TPMS to obtain a plurality of tire pressure values for said plurality of tires; and
said ESCU configured to:
receive said plurality of tire pressure values for said plurality of tires; and
utilize said plurality of tire pressure values to generate a tire pressure offset based adjustment of at least one damping characteristic of one or more of said plurality of semi-active shock assemblies.

9. The system of claim 8, wherein said ESCU is further configured to provide an offset warning, via said user interface, when a difference between at least two of said plurality of tire pressure values is outside of a predefined offset threshold value.

10. The system of claim 1, further comprising:
a communications network to communicatively couple said ESCU with said semi-active shock assembly and said TPMS, said communications network selected from a group consisting of: a wired communications network, a wireless communications network, and a hybrid communications network comprising a combination of said wired communications network and said wireless communications network.

11. The system of claim 1, wherein said semi-active shock assembly comprises:
a damper chamber;
a main piston coupled with a shaft, said main piston located within said damper chamber; and
an on-shock ESCU.

12. A suspension system comprising:
a plurality of semi-active shock assemblies configured to provide an amount of damping between a plurality of tires and a suspended portion of a vehicle;
a tire pressure management system (TPMS) to obtain a plurality of tire pressure values for said plurality of tires; and
an electronic suspension control unit (ESCU), said ESCU configured to:
receive said plurality of tire pressure values for said plurality of tires from said TPMS; and
utilize said plurality of tire pressure values, and additional data from a group consisting of: location data, performance data, terrain data, and telemetry data, to generate an adjustment of at least one damping characteristic of said semi-active shock assembly.

13. The suspension system of claim 12, further comprising:
an active valve coupled with each of said plurality of semi-active shock assemblies, said active valve configured to:
receive said adjustment from said ESCU; and
modify a damping characteristic of one or more of said plurality of said semi-active shock assemblies.

14. The suspension system of claim 12, wherein said TPMS comprises:
a plurality of tire pressure sensors, wherein each tire pressure sensor of said plurality of tire pressure sensors, obtains a tire specific tire pressure value for a given tire of said plurality of tires; and
a plurality of receivers, wherein each receiver of said plurality of receivers wirelessly communicates with a single tire pressure sensor to receive said tire specific tire pressure value.

15. The suspension system of claim 12, further comprising:
a user interface communicatively coupled with said ESCU, said user interface selected from a group consisting of: an in-vehicle infotainment (IVI) interface, a mobile device, an audible alarm, a visual alarm, and a switch.

16. The suspension system of claim 15, wherein said ESCU is configured to provide a warning, via said user interface, when at least one of said plurality of tire pressure values is outside of a pre-established terrain based threshold.

17. The suspension system of claim 15, wherein said ESCU is configured to:
utilize said plurality of tire pressure values to generate a tire pressure offset based adjustment of at least one damping characteristic of one or more of said plurality of semi-active shock assemblies.

18. The suspension system of claim 17, wherein said ESCU is configured to provide an offset warning, via said user interface, when a difference between at least two of said plurality of tire pressure values is outside of a predefined offset threshold value.

19. The suspension system of claim 12, wherein at least one of said plurality of semi-active shock assemblies comprise:
a damper chamber;
a main piston coupled with a shaft, said main piston located within said damper chamber; and
an on-shock ESCU.

20. A method of changing damping characteristics based on readings from a tire pressure management system (TPMS), said method comprising:
receiving, at an electronic suspension control unit (ESCU), a tire pressure value of a tire, said tire pressure value obtained from said tire pressure management system (TPMS);
generate an adjustment for at least one damping characteristic of an electronically adjustable shock assembly based on said tire pressure value, said electronically adjustable shock assembly coupled between said tire and a frame of a vehicle; and
modify a fluid flow path within said electronically adjustable shock assembly to alter said at least one damping characteristic of said electronically adjustable shock assembly to achieve said adjustment.
